(19) United States
(12) Patent Application Publication
(10) Pub. No.: US 2011/0167437 A1
(43) Pub. Date: Jul. 7, 2011

(54) Disc Tray

(76) Inventors: Cheng-Chung Kuan, Tao-Yuan Shien (TW); Shu-Hsu Lin, Tao-Yuan Shien (TW)

(21) Appl. No.: 12/652,125

(22) Filed: Jan. 5, 2010

(51) Int. Cl. G11B 17/04

(52) U.S. Cl. 720/609; G9B/17.013

(57) ABSTRACT

A disc tray comprises a recess, a first outer land, a second outer land, a first opening, and a second opening. Two outer lands extend upwards from the recess. Each outer land comprises an upper plane and a wall. Each wall connects the recess and each upper plane. Each opening comprises a plane opening and two upward openings. Each plane opening is located in the recess. Two upward openings are located on two edges of each plane opening, respectively, such that a protruding portion is formed on each upper plane.

### BACKGROUND OF THE INVENTION

1. Field of the Invention

The present invention relates to a disc tray, specifically to a disc tray which is environmentally friendly, secures a disc in place, facilitates insertion and removal of the disc, and decreases damage to a locking mechanism.

2. Description of the Related Art

Currently, audio or video discs are sold and displayed with disc trays/boxes. Therefore, the design of disc trays/boxes will influence the marketing outcomes.

The traditional functions of a disc tray are usually to provide enough space for a disc, prevent the data area of the disc from touching the disc tray, and providing a locking/holding mechanism for preventing the disc from moving when a user opens the disc tray. The locking/holding mechanism may consist of a plurality of fingers to lock the disc's central opening or at least two walls to hold the periphery of the disc. The patents for such mechanisms are U.S. Pat. No. 5,662,216, U.S. Pat. No. 5,593,031, and U.S. patent publication No. 2008-0245687, etc.

Most of the locking mechanisms are made of plastic materials due to their strength and elasticity. However, the quantity of plastic disc trays is enormous, which has a negative impact on the environment. Thus, instead of plastics, more and more disc trays are made of environmentally friendly materials, such as paper.

U.S. Pat. No. 5,048,681 (Walter R. Henkel), U.S. Pat. No. 5,154,284 (Merrily J. Starkey), U.S. Pat. No. 4,850,731 (Ross O. Youngs), and U.S. Pat. No. 4,620,630 (Ira L. Moss) disclose paper disc trays, but their thickness is too thin (like an envelope) to comply with the marketing standard.

Patents which are qualified as marketing standard and also use paper as their major material are listed as follows:

U.S. Pat. No. 6,073,763 (William Collins) and U.S. Pat. No. 6,494,319 (William Collins) disclose paper disc trays without a locking mechanism due to the inferior strength and elasticity of the paper.

U.S. Pat. No. 5,522,500 (Takanori Mori) discloses bellows on the side of a paper disc tray for containing a disc. However, because of the absence of a locking mechanism, the disc may easily fall out.

U.S. Pat. No. 5,088,599 (Maler) discloses a paper disc tray with a traditional box design, which involves cutting flat paper and then folding the cut paper into a disc box. However, since the design is complicated and involves many folding procedures, the cost is increased. Furthermore, the locking mechanism of U.S. Pat. No. 5,088,599 still utilizes a plurality of plastic fingers to secure a disc. In addition, like U.S. Pat. No. 5,088,599, disc trays disclosed by U.S. Pat. No. 5,188,229 and U.S. Pat. No. 5,188,230 use paper as their major materials. The locking mechanism to secure a disc is, however, made of plastics because the two patents still lack a good way to secure the disc by a means made of environmentally friendly materials.

U.S. patent publication No. 2008-0245687 discloses many embodiments. The embodiments shown in FIGS. 3˜8 utilize paperboard, and the forming process is similar to a carton. Flat paper is cut and folded into a disc tray. The embodiment shown in FIGS. 9˜13 utilizes plastics or paper (for example, by stamping). The embodiments shown in FIGS. 3˜13 feature inserting the disc into the two undercuts/slots on both sides of the disc tray. There is, however, no description in detail about how to insert the disc into the two undercuts/slots conveniently. It should be noted that the two undercuts/slots are on lateral angled walls (for example, undercuts or slots cut on the center of angled walls). Therefore, as shown in the figures, when a user inserts a disc into the two undercuts/slots, he or she has to be really careful not to tear the paper. Moreover, because the two undercuts/slots are in the centers of the lateral angled walls, the two undercuts/slots may be damaged easily if they are made of paper. Furthermore, the description emphasizes that the disc tray has to flex outwardly to facilitate insertion and removal of the disc. However, generally, users are not used to flexing the disc tray. In addition, such design may damage the paper disc tray easily. The embodiments shown in FIGS. 14˜23 utilize a central land to engage the central opening of a disc. However, the central land may be damaged easily when it is made of paper.

U.S. Pat. No. 5,422,875 (Bribach) discloses a disc tray made of paper. Its design is similar to a carton, basically. Arms are folded into two panels so as to create a space for a disc, and four protrusions are located on the arms to secure the disc. Although the disc tray is environmentally friendly, the disc will rub against the two panels when it is being removed or inserted. Moreover, because the four protrusions are mainly made of paper, the rubbing will cause damage to the four protrusions after the disc tray is used for a certain period of time such that the four protrusions may not secure the disc firmly.

Accordingly, there remains a need for a disc tray, mainly made of paper, that secures a disc in place and facilitates insertion and removal of the disc and decreases damage to a locking mechanism.

### SUMMARY OF THE INVENTION

A main objective of the present invention is to provide a disc tray mainly made of paper or other reclaimed materials.

Another objective of the present invention is to provide a disc which secures a disc in place and facilitates insertion and removal of the disc and decreases damage to a locking mechanism.

In order to achieve the above-mentioned objectives, the present invention provides a disc tray used for holding a disc. The disc tray comprises a recess, a first outer land, a second outer land, a first opening, and a second opening. The disc is placed in the recess. The recess comprises a first side and a second side. The first outer land extends upwards from the recess. The first outer land comprises a first upper plane and a first wall. The first wall connects the recess and the first upper plane. The second outer land extends upwards from the recess. The second outer land comprises a second upper plane and a second wall. The second wall connects the recess and the second upper plane. The first opening comprises a first plane opening and two first upward openings. The first plane opening is located on the first side and has two first edges. The two first upward openings are located on the two first edges of the first plane opening, respectively, such that a first protruding portion is formed in the first upper plane. The second opening comprises a second plane opening and two second upward openings. The second plane opening is located on the second side and has two second edges. The two second upward openings are located on the two second edges of the second plane opening, respectively, such that a second protruding portion is formed in the second upper plane.

When a user wants to place the disc in the disc tray, he or she first tilts the disc and inserts one side of the disc into the second opening first. Next, the user gently presses the other side of the disc until the other side of the disc passes the first protruding portion such that the other side of the disc is inserted into the first opening. Finally, the disc rests flat in the recess.

### BRIEF DESCRIPTION OF THE DRAWINGS

FIG. 1 is a perspective view of a first embodiment of the present invention.

FIGS. 2-4 are plane schematic drawings of the forming process of the first embodiment of the present invention.

FIG. 5 is a schematic drawing of the first step of the manipulating process of the first embodiment of the present invention.

FIG. 6 is a schematic drawing of the second step of the manipulating process of the first embodiment of the present invention.

FIG. 7 is a schematic drawing of the third step of the manipulating process of the first embodiment of the present invention.

FIG. 8 is a perspective view of a second embodiment of the present invention.

FIG. 9 is an enlargement of the region circled in FIG. 8.

FIG. 10 is a perspective view of a third embodiment of the present invention.

### DETAILED DESCRIPTION OF THE PREFERRED EMBODIMENT

The advantages and innovative features of the invention will become more apparent from the following detailed description when taken in conjunction with the accompanying drawings.

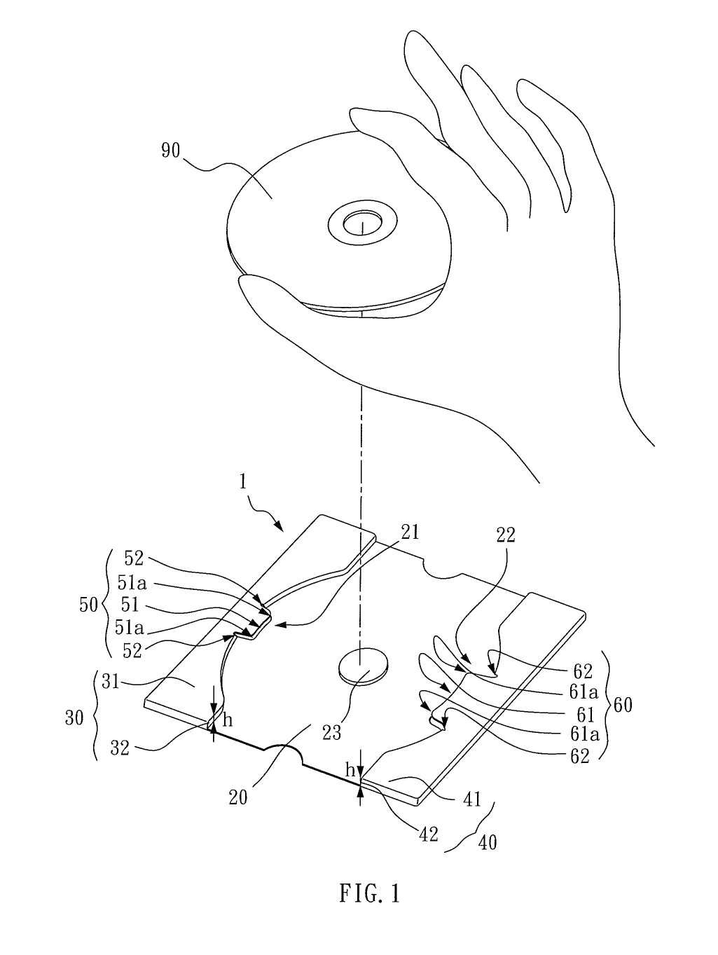

Please refer to FIG. 1, which illustrates a first embodiment of the present invention.

The present invention provides a disc tray 1 used for holding a disc 90. The disc tray 1 comprises a recess 20, a first outer land 30, a first opening 50, a second outer land 40, and a second opening 60.

The recess 20 is for receiving the disc 90. The recess 20 comprises a first side 21 (right side) and a second side 22 (left side). In this embodiment, the second side 22 is opposite to the first side 21. In addition, the center of the recess 20 comprises a central land 23. When the disc 90 is inserted, the central land 23 supports the disc 90 so as to prevent the disc 90 from rubbing against the recess 20 (see FIG. 7).

In this embodiment, as shown in FIG. 1, the first outer land 30 is located on the first side 21 of the recess 20. This can also be described in another way: the first outer land 30 is located on the left side of the recess 20. The first outer land 30 extends upwards from the recess 20. The first outer land 30 comprises a first upper plane 31 and a first wall 32. The first wall 32 connects the recess 20 and the first upper plane 31.

Similarly, the second outer land 40 is located on the second side 22 of the recess 20. This can also be described in another way: the second outer land 40 is located on the right side of the recess 20. The second outer land 40 extends upwards from the recess 20. The second outer land 40 comprises a second upper plane 41 and a second wall 42. The second wall 42 connects the recess 20 and the second upper plane 41.

In this embodiment, the height of the first wall 32 and the height of the second wall 42 should be slightly larger than the thickness of the disc 90. Thus the recommended height, h, is 0.8 mm˜4 mm (The larger height, h, is for 2 or 3 discs.).

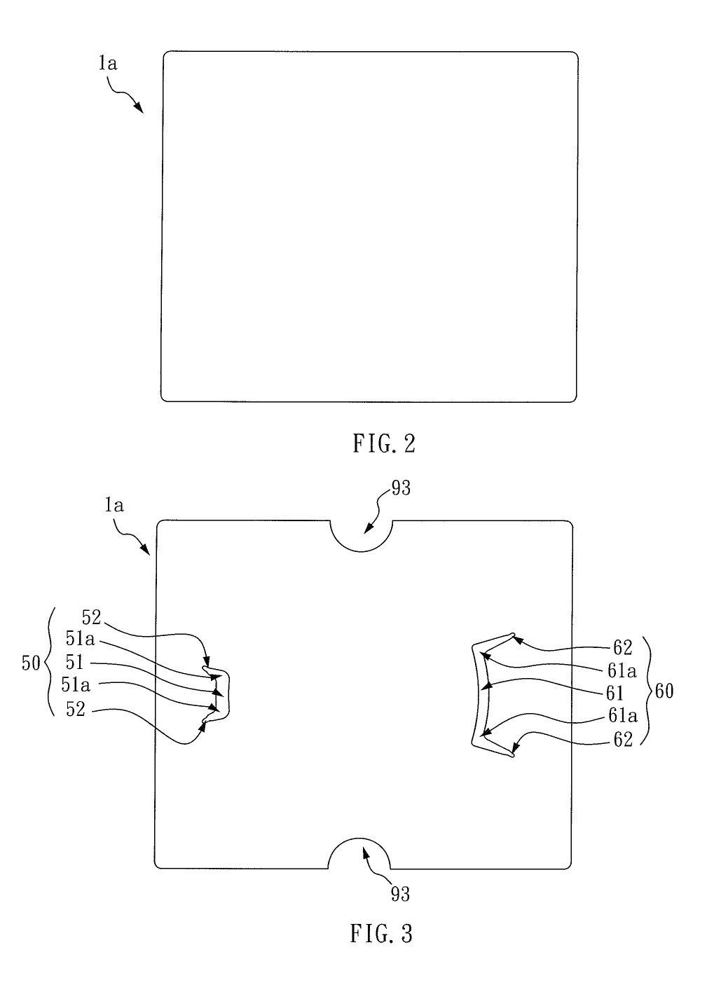

Please refer to FIGS. 2˜4, which are schematic drawings of the forming process of the first embodiment of the present invention.

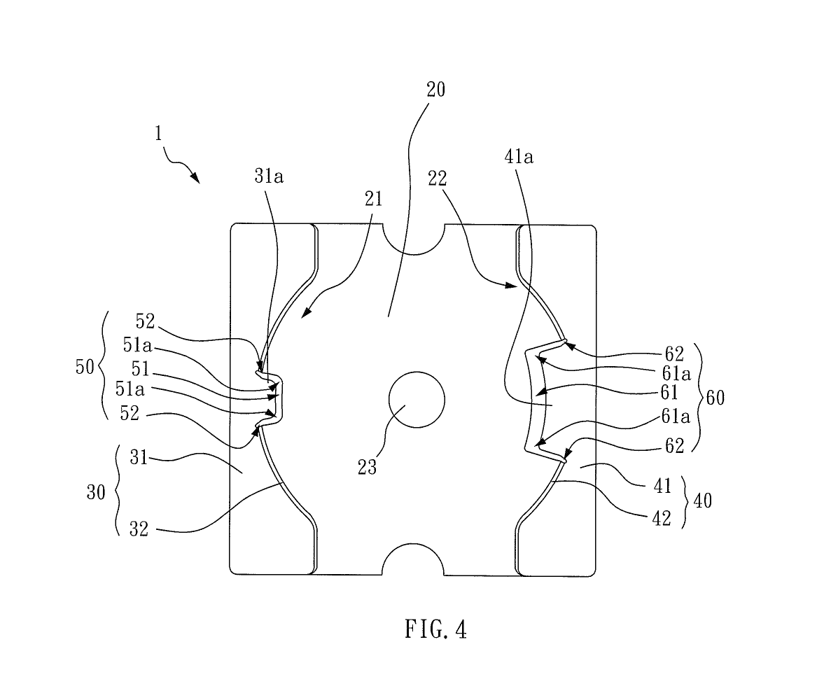

FIG. 2 shows a disc tray prior to the forming process. It is a planar sheet 1 a made of environmentally friendly materials (mainly plant fibers, such as paper fibers or grass fibers, with an additional stiffener, such as gypsum). Next, as shown in FIG. 3, the recess 20 is cut away to form the first opening 50, the second opening 60, and notches 93. Next, as shown in FIG. 4, the first outer land 30, the second outer land 40, and the central land 23 are formed by stamping.

The first opening 50 comprises a first plane opening 51 and two first upward openings 52. The first plane opening 51 is located on the first side 21 and has two first edges 51a. The two first upward openings 52 are located on the two first edges 51a of the first plane opening 51, respectively, such that a first protruding portion 31 a is formed on the first upper plane 31.

Similarly, the second opening 60 comprises a second plane opening 61 and two second upward openings 62. The second plane opening 61 is located on the second side 22 and has two second edges 61a. The two second upward openings 62 are located on the two second edges 61 a of the second plane opening 61, respectively, such that a second protruding portion 41a is formed on the second upper plane 41.

It should be noted that the first outer land 30, the first opening 50, the second outer land 40, and the second opening 60 of the present invention are not necessarily located on the left and right side. They can be located in other positions symmetrically.

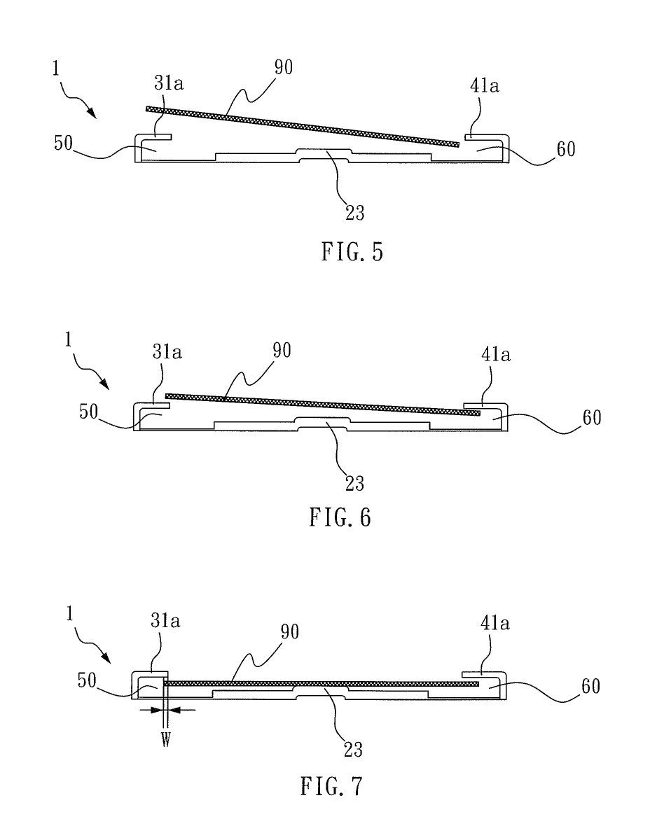

Next, please refer to FIGS. 5˜7, which are schematic drawings of the manipulating process of the first embodiment of the present invention.

As shown in FIG. 5, when a user wants to place the disc 90 in the disc tray 1, he or she tilts the disc 90 such that one side (for example, the right side in FIGS. 5-7) of the disc 90 is lower than the other side (for example, the left side in FIGS. 5-7) of the disc 90. Next, the user inserts the right side of the disc 90 into the second opening 60 such that the right side of the disc 90 touches the second wall 42 (not shown). Next, as shown in FIG. 6, the user gently presses the left side of the disc 90 until the left side of the disc passes the first protruding portion 31a such that the left side of the disc 90 is inserted into the first opening 50. Finally, as shown in FIG. 7, the center of the disc 90 is supported by the central land 23 of the disc tray 1 and rests flat. In this state, the first protruding portion 31 a and the second protruding portion 41a obstruct the disc 90 from moving away from the disc tray 1 accidentally. It should be noted that the materials of the disc tray 1 comprise materials lacking abrasion resistance, such as paper. Therefore, as shown in FIG. 7, the recommended length W of an overlap between the first protruding portion 31a and the disc 90 is 0.1 mm□0.2 mm, preferably 0.2 mm˜1.5 mm.

When the user wants to remove the disc 90 from the disc tray 1, the process is reversed. First, the user moves the left side of the disc 90 upwards until the left side of the disc 90 passes the first protruding portion 31 a such that the left side of the disc 90 is removed from the first opening 50, as shown in FIG. 6. Next, the user moves the disc 90 leftward and upward such that the right side of the disc 90 is removed from the second opening 60, as shown in FIG. 5.

In the first embodiment, the second protruding portion 41 a is larger than the first protruding portion 31 a, and the second opening 60 is bigger than the first opening 50; that is to say, the second protruding portion 41a is the main element that obstructs the disc 90 from moving away the second opening 60. The first protruding portion 31 a serves not only to obstruct the disc 90 from moving away from the first opening 50, but also as a ledge lock when the disc 90 is being inserted or removed. In order to allow the disc 90 to pass the first protruding portion 31 a easily, the first protruding portion 31a is smaller than the second protruding portion 41a. In addition, as mentioned above, the recommended length of an overlap between the first protruding portion 31a and the disc 90 is 0.1 mm□2 mm. It should be noted that the size and the design of the second protruding portion 41 a and the second opening 60 can also be the same as those of the first protruding portion 31 a and the first opening 50. Experiments, however, have shown that in such a case, the disc 90 accidentally slides out of the disc tray 1 slightly more easily.

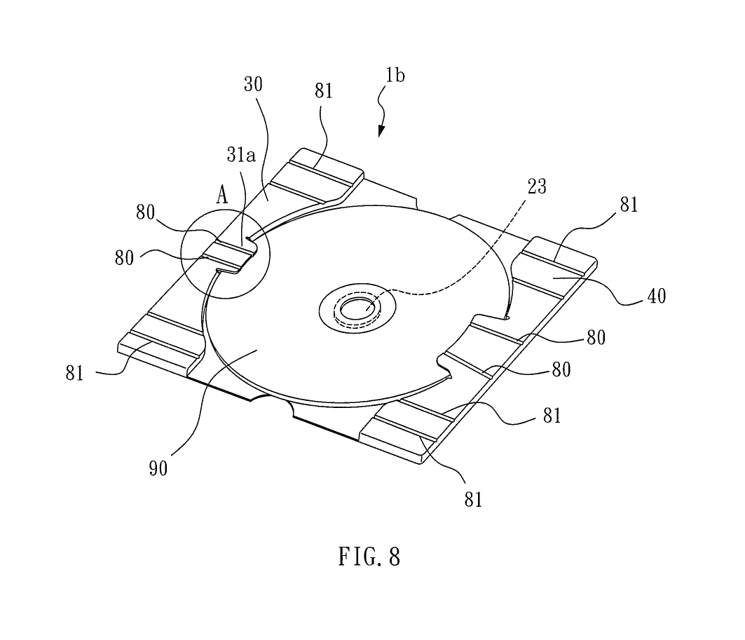

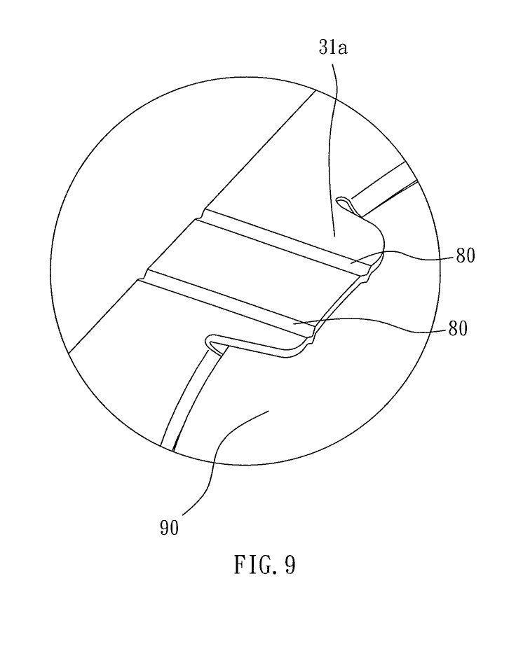

FIGS. 8 and 9 illustrate a disc tray lb of a second embodiment of the present invention. Because the first protruding portion 31a serves as a ledge lock, there may be abrasion of the first protruding portion 31a. In order to increase the strength of the first protruding portion 31a, in this embodiment, two ribs 80 are added on two sides of the first and the second protruding portions (31a, 41a), respectively (see FIG. 9 for an enlargement of the region circled in FIG. 8). The ribs 80 can be formed by stamping (please refer to the above description of FIG. 4). Similarly, a plurality of ribs 81 can also be added in order to increase the structural strength of the first outer land 30 and the second outer land 40.

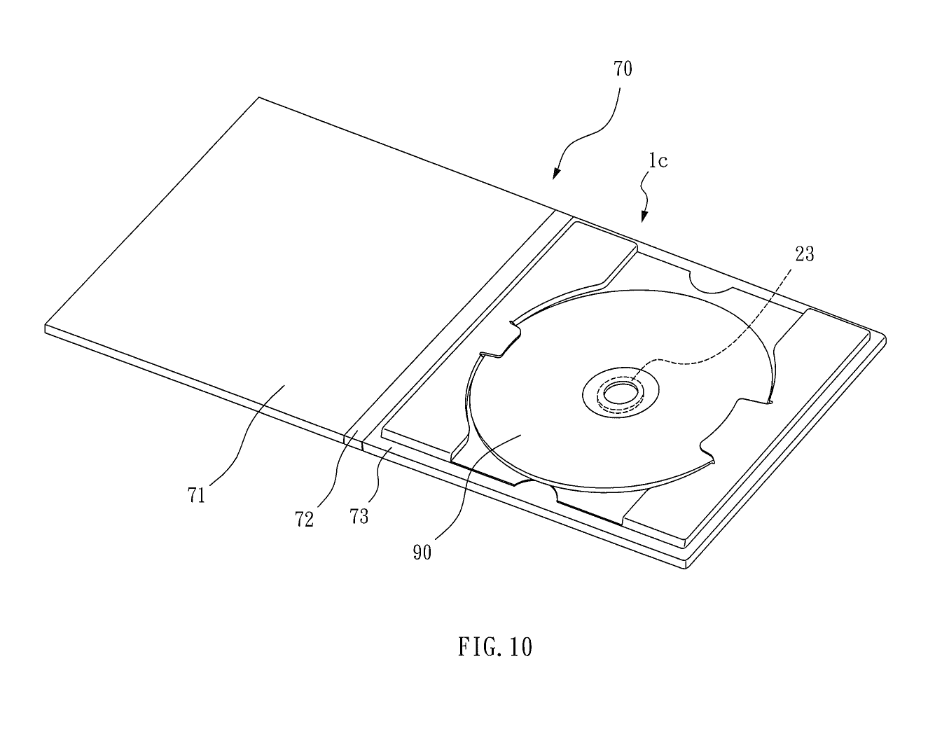

Please refer to FIG. 10, which illustrates a third embodiment of the present invention. In this embodiment, a disc tray 1 c further comprises a cover 70. The cover 70 comprises a top plate 71, a spine 72, and a bottom plate 73. The bottom plate 73 is connected to the recess 20. The width of the spine 72 is about the thickness of the disc tray 1c. The user can open or close the top plate 71 to remove the disc 90 from the disc tray 1c or place the disc 90 in the disc tray 1c. The disc tray 1c having the cover 70 of the third embodiment meets the specification for a disc tray on the market at the present time.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A disc tray used for holding a disc, comprising:
a recess for receiving the disc, wherein the recess comprises a first side and a second side;
a first outer land extending upwards from the recess, wherein the first outer land comprises a first upper plane and a first wall, and the first wall connects the recess and the first upper plane;
a second outer land extending upwards from the recess, wherein the second outer land comprises a second upper plane and a second wall, and the second wall connects the recess and the second upper plane;
a first opening comprising a first plane opening and two first upward openings, wherein the first plane opening is located on the first side and has two first edges, and the two first upward openings are located on the two first edges of the first plane opening, respectively, such that a first protruding portion is formed on the first upper plane; and
a second opening comprising a second plane opening and two second upward openings, wherein the second plane opening is located on the second side and has two second edges, and the two second upward openings are located on the two second edges of the second plane opening, respectively, such that a second protruding portion is formed on the second upper plane.

2. The disc tray as claimed in claim 1, wherein the second side is opposite to the first side.

3. The disc tray as claimed in claim 2, wherein when the disc is placed in the recess, a length of an overlap between the first protruding portion and the disc is 0.1 mm□2 mm.

4. The disc tray as claimed in claim 3, wherein the length of the overlap between the first protruding portion and the disc is further restricted to 0.2 mm□1.5mm.

5. The disc tray as claimed in claim 4, wherein the height of the first wall and the height of the second wall are 0.8 mm˜4 mm, and the main material of the disc tray comprises plant fibers.

6. The disc tray as claimed in claim 5, wherein the second opening is bigger than the first opening.

7. The disc tray as claimed in claim 6, wherein the second protruding portion is larger than the first protruding portion.

8. The disc tray as claimed in claim 7, wherein the disc tray further comprise a cover, which comprises a top plate, a spine, and a bottom plate, wherein the bottom plate is connected to the recess.

9. The disc tray as claimed in claim 8, wherein the recess comprises a central land; when the disc is held in the disc tray, the disc contacts the central land.

10. The disc tray as claimed in claim 9, wherein the first protruding portion and the second protruding portion comprise at least one rib, respectively.

11. The disc tray as claimed in claim 10, wherein the first side and the second side are located on the left side and the right side of the recess, respectively.

12. The disc tray as claimed in claim 1, wherein when the disc is placed in the recess, a length of an overlap between the first protruding portion and the disc is 0.1 mm□2mm.

13. The disc tray as claimed in claim 12, wherein the second side is opposite to the first side.

14. The disc tray as claimed in claim 13, wherein the main material of the disc tray comprises plant fibers.

15. The disc tray as claimed in claim 14, wherein the first side and the second side are located on the left side and the right side of the recess, respectively.

16. The disc tray as claimed in claim 15, wherein the height of the first wall and the height of the second wall are 0.8 mm˜4 mm.

17. The disc tray as claimed in claim 16, wherein the second opening is bigger than the first opening, and the second protruding portion is larger than the first protruding portion.

18. The disc tray as claimed in claim 1, wherein the disc tray further comprises a cover, which comprises a top plate, a spine, and a bottom plate, wherein the bottom plate is connected to the recess.

19. The disc tray as claimed in claim 18, wherein the second side is opposite to the first side.

20. The disc tray as claimed in claim 19, wherein when the disc is placed in the recess, a length of an overlap between the first protruding portion and the disc is 0.1 mm□2 mm, and the main material of the disc tray comprises plant fibers.
